(19) United States
(12) Patent Application Publication
(10) Pub. No.: US 2020/0202265 A1
(43) Pub. Date: Jun. 25, 2020

(54) AUTOMATED PARENTING OF WORK ITEMS IN A RESOURCE MANAGEMENT STRUCTURE

(71) Applicant: Microsoft Technology Licensing, LLC, Redmond, WA (US)

(72) Inventors: Naveen Sethuraman NAIR, Kenmore, WA (US); Jill House CAMPBELL, Seattle, WA (US); Lisa Mary KLINK, Bellevue, WA (US); Nir MICHAELY, Redmond, WA (US)

(21) Appl. No.: 16/229,984

(22) Filed: Dec. 21, 2018

(51) Int. Cl. G06Q 10/06; G06F 9/50; G06F 8/41; G06F 8/70; G06F 17/24

(52) U.S. Cl. CPC G06Q 10/0631; G06F 9/5027; G06F 17/243; G06F 8/433; G06F 8/70; G06F 9/5016

(57) ABSTRACT

Automatically parenting a work item in a resource management structure. An embodiment identifies a work item that corresponds to a source code item (e.g., file) in a source code database, and that is associated with a user. Based on the historical data relevant to the work item, parent(s) of the work item are identified in a resource management structure. The parent(s) represent software feature(s) to which the work item contributes. The historical data includes one or more of first prior work item mapping(s) by the user, second prior work item mapping(s) by peer(s) of the user, or third prior work item mapping(s) associated with the source code item. The work item is associated with the parent(s) of the work item in the resource management structure. Implementations can the use the association to automatically populate a user interface data field, or to automatically allocate computer hardware resources.

### BACKGROUND

Software development can involve a creation of a data items relating to both release planning and the progress of release development. For example, project managers/planners may create data items relating to the higher-level planning for a software release (e.g., data items defining release goals, data items defining software features needed to accomplish those goals, etc.), while software developers may create data items relating to the actual implementation of those features/goals in the software product (e.g., code repository pull requests, bug requests, etc.).

### BRIEF SUMMARY

As the size of a given software product increases, and/or the size of the company developing the software product increases, it can be challenging to maintain associations between developer-created data items and the higher-level software goals/features they correspond to, creating a disconnect between release planning data and release development data. Embodiments herein bridge the gap between release planning data and release development data by automatically parenting developer-created work items with higher-level release goals, software features, etc.

In particular, embodiments herein leverage historical information relating to a developer-created work item to auto parent a work item object with appropriate parent object(s) in a resource management data structure. This historical information can be selected from, for example, information about prior work by a user associated with the work item (e.g., a creator, an assignee, etc.), information about prior work by one or more peers of that user (e.g., a developer's team members), information about the history of the source code item the work item affects, and the like. Based on analysis of this historical information, embodiments can automatically identify one or more parent data objects representing software features to which the work item relates, release goals to which the work item relates, etc. Based on identifying these parent data object(s), embodiments can automatically insert or link work item object to appropriate location(s) in the resource management data structure (e.g., as a child object in a tree structure).

Not only can these automatically created parent object associations in the resource management data structure provide valuable information to managers (e.g., about how development is progressing toward the accomplishment of target goals/features, about how much different developers/development teams have contributed to the accomplishment of target goals/features, and the like), in embodiments these automatically created associations can provide many technical benefits. For example, these associations can be used by a computer system to provide improved user interfaces by, for example, auto-populating one or more data fields in a user interface for creating or modifying a work item with the automatically determined parent(s), a software product family to which the work item contributes, a software product to which the work item contributes, a software release to which the work item contributes, and the like. This, in turn, can reduce the number of user inputs it takes to create a work item that is properly associated with any applicable parent(s).

In another example, these associations can be used by a computer system to automatically make computing resource allocations. For example, the resource management data structure could be used to automatically determine users and/or teams who could benefit from additional cloud computing resources. Based on this determination, a resource management engine might allocate additional hardware resources to computer systems associated with these users/teams—such as allocating processing and/or memory resources to increase a number of concurrent build jobs that are possible, allocating storage resources for storing caches of source code repositories, allocating networking resources to decrease the amount of time is takes to download source code repositories, etc.

Some embodiments are directed to methods, systems, and computer program products for automatically parenting a work item in a resource management structure. These embodiments include identifying a work item that corresponds to at least one source code item in a source code database, the work item being associated with a user. Historical data relevant to the work item is identified. The historical data includes one or more of (i) one or more first prior work item mappings by the user associated with the work item, (ii) one or more second prior work item mappings by one or more peers of the user associated with the work item, or (iii) one or more third prior work item mappings associated with the source code item. Based on the identified historical data relevant to the work item, one or more parents of the work item are identified in a resource management structure. The one or more parents represent one or more software features to which the work item contributes. The work item is associated with the one or more parents of the work item in the resource management structure. These embodiments might then automatically populate a user interface data field corresponding to the work item with the identified one or more parents, a software product family, a software product, a release version, and the like, or automatically allocate of at least one of storage hardware resources, processing hardware resources, memory hardware resources, or networking hardware resources to a computer system associated with the work item.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a computer system that automatically parents work items in a resource management structure;

FIG. 2 illustrates an example of a resource management structure; and

FIG. 3 illustrates a flow chart of an example method of automatically parenting a work item in a resource management structure.

### DETAILED DESCRIPTION

Embodiments herein bridge the gap between release planning data and release development data by automatically parenting developer-created work items with higher-level release goals, software features, etc. In particular, embodiments herein leverage historical information relating to a developer-created work item to auto parent a work item object with appropriate parent object(s) in a resource management data structure. This historical information can be selected from, for example, information about prior work by a user associated with the work item (e.g., a creator, an assignee, etc.), information about prior work by one or more peers of that user (e.g., a developer's team members), information about the history of the source code item the work item affects, and the like. Based on analysis of this historical information, embodiments can automatically identify one or more parent data objects representing software features to which the work item relates, release goals to which the work item relates, etc. Based on identifying these parent data object(s), embodiments can automatically insert or link work item object to appropriate location(s) in the resource management data structure (e.g., as a child object in a tree structure).

Not only can these automatically created parent object associations in the resource management data structure provide valuable information to managers (e.g., about how development is progressing toward the accomplishment of target goals/features, about how much different developers/development teams have contributed to the accomplishment of target goals/features, and the like), in embodiments these automatically created associations can provide many technical benefits. For example, these associations can be used by a computer system to provide improved user interfaces by, for example, auto-populating one or more data fields in a user interface for creating or modifying a work item with one or more of the automatically determined parent(s), a software product family to which the work item contributes, a software product to which the work item contributes, a software release to which the work item contributes, and the like. This, in turn, can reduce the number of user inputs it takes to create a work item that is properly associated with any applicable parent(s).

In another example, these associations can be used by a computer system to automatically make computing resource allocations. For example, the resource management data structure could be used to automatically determine users and/or teams who could benefit from additional cloud computing resources. Based on this determination, a resource management engine might allocate additional hardware resources to computer systems associated with these users/teams—such as allocating processing and/or memory resources to increase a number of concurrent build jobs that are possible, allocating storage resources for storing caches of source code repositories, allocating networking resources to decrease the amount of time is takes to download source code repositories, etc.

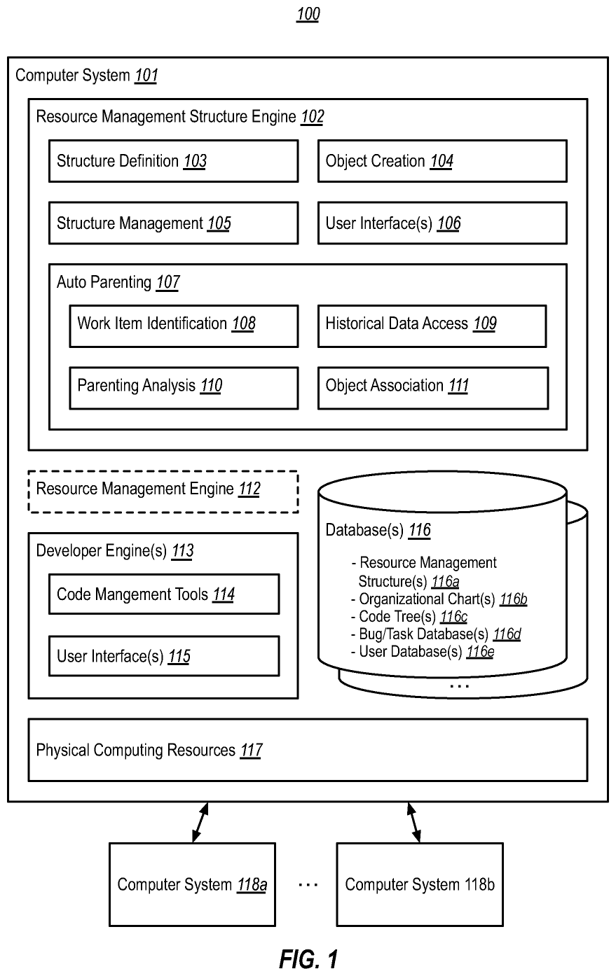

To the accomplishment of the foregoing, FIG. 1 illustrates an example of a computing environment 100 that automatically parents work items in a resource management structure. As shown, computing environment 100 can include a computer system 101 that includes a plurality of components/engines (e.g., resource management structure engine 102, resource management engine 112, developer engine(s) 113, etc.) and data (e.g., contained in database(s) 116) for performing the functionality described herein. This computer system can be communicatively connected to one or more end-user computer systems 118 via one or more network communications links (e.g., comprising one or more local area networks, one or more wide area networks, the Internet, etc.). It will be appreciated that computer system 101 can comprise a single physical computer system, or a plurality of different computer systems. As such, the functionality and data described in connection with computer system 101 could be implemented at a single computer system, or could be distributed among a plurality of distinct computer systems (e.g., in a cloud computing environment).

As shown, computer system 101 includes a resource management structure engine 102 that manages one or more resource management data structures 116a (e.g., stored in database(s) 116). As briefly summarized above, a resource management data structure 116a contains information relevant to creating a software release, such as release goals and software product features, as well as information relating to developer-created work items that actually implement those goals/features. As depicted, the resource management structure engine 102 includes a variety of components (e.g., structure definition 103, object creation 104, structure management 105, user interface(s) 106, and/or auto parenting 107) that can operate together to manage resource management data structures 116a. It will be appreciated that these components—including their identity and arrangement—are depicted merely as an aid in describing various embodiments of the resource management structure engine 102 described herein, and that these components are non-limiting to how software and/or hardware might implement various embodiments of the resource management structure engine 102 described herein, or of the particular functionality thereof.

The structure definition component 103 defines a taxonomy of the particular types and organization of data that can be stored within the management data structures 116a. For example, the structure definition component 103 might read and/or write declarative data, such as data defined using the Extensible Markup Language (XML), the JavaScript Object Notation (JSON), and the like, that defines said taxonomy. In embodiments, this taxonomy defines available object types that can be created, including how these object types can be interrelated to form one or more hierarchical structures of nodes (e.g., trees, graphs, and the like). Based on a request (e.g., a request received from a user computer system 118 at user interface(s) 106 or user interface(s) 115), the object creation component 104 creates one or more objects in accordance with the taxonomy defined by the structure definition component 103 for insertion into the resource management structure(s) 116a. The structure management component 105 manages the associations between these objects in the resource management structure(s) 116a, thereby defining their arrangement into hierarchical structure(s). The structure management component 105 might define associations between objects based on user input (e.g., received from a user computer system 118 at user interface(s) 106 or user interface(s) 115), or automatically (e.g., based on analysis performed by the auto parenting component 107). The user interface(s) 106 provide mechanisms for user computer systems 118a to interact directly with the taxonomy defined by the structure definition component 103 and/or with the management data structures 116a.

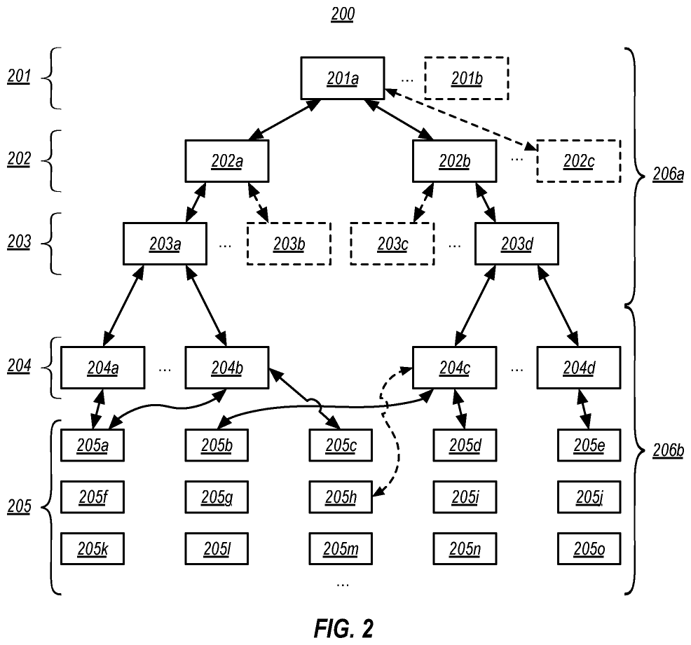

While the structure definition component 103 can define a vast variety of taxonomies, resulting in a vast variety resource management structures 116a, FIG. 2 illustrates one example of a resource management structure 200, according to one or more embodiments. As shown, resource management structure 200 can comprise a plurality of levels of nodes (e.g., levels 201, 202, 203, 204, and 205). In embodiments, these levels of nodes might form two (or more) general groupings 206a/206b. For example, grouping 206a (comprising node levels 201-203) might correspond to data objects relating to project planning and management, while grouping 206b (comprising node levels 204 and 205) might correspond to data objects relating to actual development that results from the project planning/management.

To illustrate, one project planning/management technique might begin by defining a “story” that will be communicated to customers in connection with a software release—such as benefits that a new software release will provide to customers (e.g., in order to motivate them to update). One story for an operating system update, for example, may be that the new operating system release will better enable a company's users to work productively while traveling. Node level 201 can include top-level data objects/nodes representing each of these stories. Thus, for example, in resource management structure 200, node 201a may represent the customer story that an operating system update that is being planned should better enable users to work productively while traveling. As indicated by the corresponding ellipses and node 201b (shown in broken lines), there could be any number of customer stories—each having a hierarchy of lower-level nodes below them (not shown).

The illustrative project planning/management technique might then define one or more concrete customer promises that are made in connection with each of these stories. Continuing the example story above, for example, customer promises may include the operating system update resulting in better battery life, the operating system update supporting better offline productivity, etc. Node level 202 can include data objects/nodes representing each of these customer promises. Thus, for example, in resource management structure 200, node 202a may represent the customer promise that the operating system update needs to result in better battery life, and node 202b may represent the customer promise that the operating system update needs to result in better offline productivity. As indicated by the corresponding ellipses and node 202c (shown in broken lines), there could be any number of customer promises—each having a hierarchy of lower-level nodes below them (not shown).

The illustrative project planning/management technique might then define one or more scenarios that need to be covered by each of these customer promises. Continuing the example story above, for example, an example scenario for customer promise 202a could include managing resource allocations among concurrently running tasks when running on battery power, while a scenario for customer promise 202b could include running web applications in an offline state. Node level 203 can include data objects/nodes representing each of these customer promises. Thus, for example, in resource management structure 200, node 203a may represent the scenario of managing resource allocations among concurrently running tasks when running on battery power, and node 203d may represent the scenario of running web applications in an offline state. As indicated by the corresponding sets of ellipses and nodes 203b and 203c (shown in broken lines), there could be any number of scenarios for each customer promise—each having a hierarchy of lower-level nodes below them (not shown).

The nodes in grouping 206a (e.g., node levels 201-203, relating to project planning/management) are generally be created based on user interactions by project planners/managers with user interface(s) 106—which relate directly to management of the resource management structure(s) 116a. As such, the associations between these objects are generally defined at each object's creation.

Moving from grouping 206a to grouping 206b (e.g., node levels 204 and 205, relating to software development), each scenario might be broken down into one or more deliverables (node level 204) that are produced by developer/feature teams. For example, scenario 203a (i.e., managing resource allocations on battery power) may include a deliverable 204a of managing the triggering of software interrupts to reduce processor wake states and a deliverable 204b of managing how various processes are scheduled processor time. Scenario 203d (i.e., running web applications in an offline state), on the other hand, may include a deliverable 204c of implementing offline browser storage and a deliverable 204d of implementing an offline web application engine. Again, there could be any number of deliverables for any given scenario (as indicated using ellipses).

Notably, one or more of the nodes in node levels 201-204 could include information about the software product/release to which they apply. For example, these nodes could include one or more data fields that identify such things as the software product family to which the node applies, the software product to which the node applies, the release version to which the node applies, etc.

Work items (node level 205) represent individual tasks completed by developers as part of implementing and refining the deliverables in node level 204. For example, a work item might be a task (e.g., relating to implementing new code) or a bug (e.g., relating to fixing/modifying existing code) created against source code in a code tree 116b. These work items can be associated with their parent deliverables. Thus, for example, in resource management structure 200, work item 205a is associated with deliverables 204a and 204b, work item 205b is associated with deliverable 204c, work item 205c is associated with deliverable 204b, etc.

While work items can be a part of the resource management structure(s) 116a, they are often created based on activity that is somewhat separate from the resource management structure(s) 116a. For example, individual work items might be created based on interactions by developers at end-user computer systems 118 with the developer engine(s) 113. In general, the developer engine(s) 113 represent the software tools that manage source code and build tools used by developer teams. Thus, for example, the developer engine(s) 113 can include code management tools 114, such as build farms, source code repositories, source code version control systems, source code bug tracking and testing tools, etc. In general, these code management tools 114 can include (or be associated with) various user interfaces 115, and can store and operate on data stored in the database(s) 116 (e.g., code tree(s) 116c, bug/task database(s) 116d, and the like). Thus, an individual work item in the resource management structure(s) 116a might be created based on a developer-created task checking code into a code tree 116c, based on a developer-created bug or problem report created in the bug/task database(s) 116d, etc. For example, based on creation of a task or bug, the developer engine(s) 113 might call the object creation component 104 to create a work item in the resource management structure 200—or to at least link an object stored in another database (e.g., a code tree 116c, a bug/task database 116d, etc.) the into the resource management structure 200 as a work item.

Because work items may be created based on activity and data that is separate from the resource management structure(s) 116a and/or that is not under direct control of the resource management structure engine 102, individual work items may not be associated with their parent objects/nodes (e.g., stories, customer promises, scenarios, deliverables, etc.) when they are created, and may lack identifying information such as the software product family, software product, release version, etc. to which the work item contributes. For example, while user interface(s) 115 might provide an ability for developers to link a work item (e.g., task, bug, etc.) with parent object(s) in the resource management structure(s) 116a, and/or to populate data fields with identifying information such as software product family, software product, release version, etc., it may be the case that developers choose to leave these parent associations and/or data fields blank. As such, it may not be uncommon for work items to be orphaned in the resource management structure(s) 116a after their creation, and for work items to lack information about the software product family, software product, release version, etc. to which the work item contributes. For example, in FIG. 2, resource management structure 200 includes many orphan work items (e.g., work items 205f-205o, which lack any mapping to parent work items). As such, there can be a disconnect between development data and project planning/management data in resource management structure(s) 116a.

As such, the resource management structure engine 102 includes an auto parenting component 107, which automatically determines likely parent node(s) in the resource management structure(s) 116a that a given work item node might be associated with. In general, the auto parenting component 107 uses historical data associated with individuals and/or code to determine possible parents for a given work item. As depicted, the auto parenting component 107 includes a variety of sub-components (e.g., work item identification 108, historical data access 109, parenting analysis 110, and/or object association 111) that can operate together to auto-parent work items. It will be appreciated that these sub-components—including their identity and arrangement—are depicted merely as an aid in describing various embodiments of the auto parenting component 107 described herein, and that these sub-components are non-limiting to how software and/or hardware might implement various embodiments of the auto parenting component 107 described herein, or of the particular functionality thereof.

The work item identification component 108 identifies work items on which to perform an auto parenting analysis. There could be a variety of situations in which work item identification component 108 operates (which could be implemented singly or in combination). For example, the work item identification component 108 might periodically scan the resource management structure(s) 116a for orphan work items (i.e., any work item that lacks parent associations, such as work items 205f-205o), and initiate an auto parenting analysis on any identified orphan work items. In another example, the work item identification component 108 might be invoked after creation of a work item. In this example, the work item identification component 108 might initiate an auto parenting analysis based on work item being inserted (or linked) into the resource management structure(s) 116a. In another example, the work item identification component 108 might be invoked during creation of a work item. In this example, work item identification component 108 might initiate an auto parenting analysis that assists a user in creation of the work item (e.g. by auto-populating one or more data fields within user interface(s) 115 that are being used to create the work item) prior to it being inserted into the resource management structure(s) 116a.

After the work item identification component 108 has selected a given work item for an auto parenting analysis, the historical data access component 109 identifies historical data relevant to this subject work item. The historical data can leverage any data available in the database(s) 116, such as organizational chart(s) 116b, code tree(s) 116c, bug/task database(s) 116d, user database(s) 116e, etc.

For example, historical data might include historical information relating to the user associated with the subject work item, such as the user who created the work item and/or a user to whom the work item is assigned. For instance, the historical data access component 109 might use the code tree(s) 116d and/or the bug/task database(s) 116d—potentially in combination with the resource management structure(s) 116a—to identify prior work items (e.g., relating to tasks/bugs) that are associated with the user. Then, the historical data access component 109 can identify the parent mappings for these work items. Since developers frequently work on related code, these prior work item mappings can be informative as to which mapping may be appropriate for the current subject work item. In embodiments, the historical data access component 109 might limit its search based on a rolling time window (e.g., the prior 30 days, the prior 45 days, the prior 90 days, etc.). By doing so, historical data access component 109 can limit itself accessing information relating only to recent work items. This can, in turn, limit the historical information to only projects that the user has recently been working on.

In another example, historical data might include information relating to peers of the user associated with the work item. For instance, the historical data access component 109 might use the code tree(s) 116c and/or the user database(s) 116e to identify the user's peers, such as users on the same development team, the user's manager, etc. Then, the historical data access component 109 can identify work items associated with those peer users, including prior work item mappings by those peer users. Again, the historical data access component 109 might limit its search based on a rolling time window (e.g., the prior 30 days, the prior 45 days, the prior 90 days, etc.).

In yet another example, historical data might include information relating to prior work item mappings associated with source code item(s) affected by the work item. For instance, the historical data access component 109 might identify one or more source code file(s) that that are affected by the task/bug associated with the subject work item. Then, using the code tree(s) 116d and/or the bug/task database(s) 116d—potentially in combination with the resource management structure(s) 116a—the historical data access component 109 can identify prior work item mappings that were associated with those source code file(s).

The parenting analysis component 110 utilizes the historical information identified by the historical data access component 109 to automatically determine one or more likely parent object/nodes of the subject work item in the resource management structure(s) 116a. The parenting analysis component 110 might use one type of historical information singly (e.g., only historical parenting information relating to the user, only historical parenting information relating to the user's peers, only historical parenting information relating to the source code, etc.), or might use any combination of two or more types of historical information. In embodiments, when using multiple types of historical information, the parenting analysis component 110 could apply a weighting to the different types of historical information, and/or consider the frequency of occurrence of particular parent mappings in this historical information. The parenting analysis component 110 could even apply weightings within a single type of historical information. For example, the parenting analysis component 110 could identify parenting information relating to the user over a broad period of time, but apply a greater weight to more recent parenting information (e.g., the last 30 days, the last 45 days, etc.).

Based whatever combination of historical information used, the parenting analysis component 110 could identify one or more parent objects/nodes in the resource management structure(s) 116a that are likely to by the subject work item's parents. If there is insufficient or conflicting historical information, the parenting analysis component 110 might determine that no likely parent object/nodes can be determined. If this is the case, parenting analysis component 110 might send a notice to the user associated with the subject work item and request an express parenting input. In these situations, the auto parenting component 107 might apply any user input to correct the associations, and as an aid in making future auto parenting decisions—such as by updating relevant historical data, updating a machine learning model, and the like.

Based on the parent objects/nodes identified by the parenting analysis component 110 (either automatically or with user input), the object association component 111 associates those parent objects/nodes with the subject work item in the resource management data structure(s) 116a. This could include, for example, the object association component 111 calling the structure management component 105. In embodiments, the object association component 111 might associate a work item stored in the resource management structure(s) 116a with parent objects/nodes, or might link a work item stored in some other database (e.g., code tree(s) 116d, bug/task database(s) 116d, etc.) with parent objects/nodes in the resource management structure(s) 116a.

As mentioned, the auto parenting component 107 might auto-fill one or more data fields in a user interface based on an auto parenting analysis, particularly if the work item identification component 108 is triggered during creation of a work item. For example, the auto parenting component 107 might auto-fill one or more data fields identifying the auto-determined parent objects/nodes. In another example, the auto parenting component 107 might auto-fill one or more data fields identifying the software product family, software product family, release version, etc., to which the work item contributes (i.e., as determined from data available in the parent nodes). Thus, the object association component 111 could provide the user interface(s) 115 with any of the foregoing information so that this information can be auto-filled into one or more user interface fields (e.g., drop-down menus, combo boxes, text input boxes, and the like). In embodiments, if a user modifies an auto-filled user interface field, the auto parenting component 107 might update the corresponding information in the resource management data structure(s) 116a (e.g., parent associations, data fields in the parent nodes, etc.), and apply this new information to aid in making future auto parenting decisions—such as by updating relevant historical data, updating a machine learning model, and the like.

As shown, computer system 101 can include a variety of physical computing resources 117. These can include for example, storage resources, processing resources, memory resources, networking resources, etc. As discussed, computer system 101 could embody any number of physical computer systems. Thus, in embodiments, physical computing resources 117 could be cloud computing resources, network infrastructure resources, etc. As depicted, computer system 101 might also include a resource management engine 112, which can operate to make allocations of these physical computing resources 117 to computer systems (such as end-user computer systems 118 associated with particular users). In embodiments, the resource management engine 112 utilizes the information in the resource management structure(s) 116a, including auto parenting associations made the auto parenting component 017, to automatically allocation or reallocate the physical computing resources 117 to other computer systems/users.

For example, based on parenting information in the resource management structure(s) 116a, the resource management engine 112 might determine that there are a low number of work items for particular parent(s) in the resource management structure(s) 116a, or that work items are being created at an undesirable rate. The resource management engine 112 might also determine that a lack of computing resources contributes to these deficiencies. As such, the resource management engine 112 might allocate additional resources from the physical computing resources 117 to computer systems (e.g., end-user computer systems 118) associated with users who are on the development team working on code for those parent(s). For example, the resource management engine 112 might allocate processing and/or memory resources to increase a number of concurrent build jobs that are possible, might allocate storage resources to store copies/caches of source code repositories, might allocate networking resources to decrease the amount of time is takes to download source code repositories, etc. This allocation of resources might even take away physical computing resources 117 from other development teams, such as teams that have completed implementation their assigned parent(s) in the resource management structure(s) 116a, thereby reallocating underutilized physical computing resources 117.

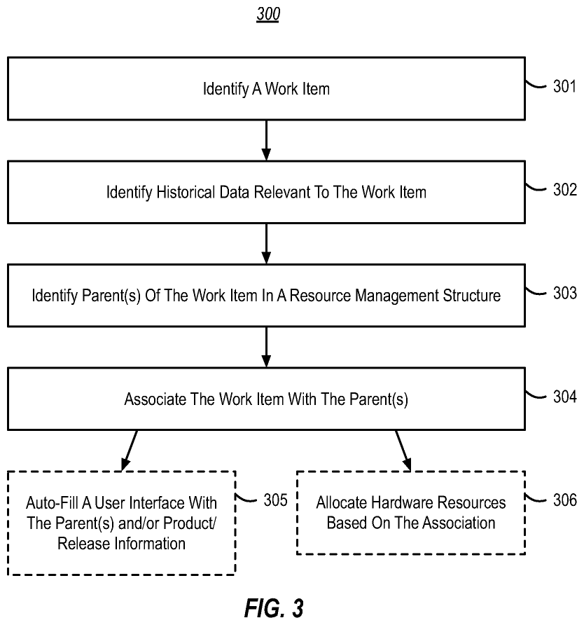

In view of the foregoing, FIG. 3 illustrates a flowchart of an example method 300 for automatically parenting a work items in a resource management structure. Method 300 will now be described in view of the architectures, components, and examples of FIGS. 1 and 2.

As shown in FIG. 3, method 300 includes an act 301 identifying a work item. In some embodiments, act 301 comprises identifying a work item that corresponds to at least one source code item in a source code database, the work item being associated with a user. For example, the work item identification component 108 can identify a work item for an auto parenting analysis. As discussed, this could be done as part of a periodic task searching for orphan work items, as part of insertion of a work item into a resource management data structures 116a, as part of creation of a work item at a user interface, etc. In FIG. 2, for example, the work item identification component 108 might identify work item 205h—which could correspond, for example, with at least one of a bug or a task (e.g., in bug/task database(s) 116d) associated with at least one source code file (e.g., in code tree(s) 116c).

Method 300 also includes an act 302 of identifying historical data relevant to the work item. In some embodiments, act 302 comprises identifying historical data relevant to the work item, the historical data including one or more of (i) one or more first prior work item mappings by the user associated with the work item, (ii) one or more second prior work item mappings by one or more peers of the user associated with the work item, or (iii) one or more third prior work item mappings associated with the source code item. For example, the historical data access component 109 can access historical data, such as data available in organizational chart(s) 116b, code tree(s) 116c, bug/task database(s) 116d, user database(s) 116e, and the like. As discussed, the historical data might include data about prior work item parenting by the user associated with work item 205h, prior work item parenting by that user's peers (e.g., team members, managers, etc.), or source code files associated with work item 205h.

Method 300 also includes an act 303 of identifying parent(s) of the work item in a resource management structure. In some embodiments, act 303 comprises, based on the identified historical data relevant to the work item, identifying one or more parents of the work item in a resource management structure, the one or more parents representing one or more software features to which the work item contributes. For example, based on the historical data identified in act 302 by the historical data access component 109, the parenting analysis component 110 can identify one or more likely parent objects/nodes of the work item in the resource management structure(s) 116a As mentioned, when performing a parenting analysis, the parenting analysis component 110 could consider—singly, or in combination—the first prior work item mapping(s) by the user, the second prior work item mapping(s) by the user's peers, third prior work item mapping(s) associated with the source code item, and the like. In embodiments, when considering two or more factors in combination, parenting analysis component 110 might weight one type of mapping differently than another, or might consider the frequency of occurrence of certain mappings. Returning to FIG. 2, when considering work item 205h, the parenting analysis component 110 might identify story 201a, customer promise 202b, scenario 203d, and deliverable 204c.

Method 300 also includes an act 304 of associating the work item with the parent(s). In some embodiments, act 304 comprises associating the work item with the one or more parents of the work item in the resource management structure. For example, based on the analysis by the parenting analysis component 110 and act 303, the object association component 111 can automatically associate work item 205h with the identified parents (i.e., story 201a, customer promise 202b, scenario 203d, and deliverable 204c), as shown by the broken arrow between work item 205h and deliverable 204c. While, in FIG. 2, work items are directly associated with deliverables, it is noted that work items could be directly associated with parent objects/nodes in any node level, or with multiple parent objects/nodes in the same node level.

Associating the work item with parent(s) might be accomplished by inserting the work item 205h as an object in the resource management structure(s) 116a (e.g., as an object that is inserted hierarchically below one or more objects representing the parent(s) in the resource management structure). Alternatively, associating the work item with parent(s) might be accomplished by linking the work item 205h into the resource management structure(s) 116a. This linking might include linking to an object in a source code database (e.g., code tree(s) 116c), a bug database (e.g., bug/task database(s) 116d), and the like.

As shown, method 300 can also include an act 305 of auto-filling a user interface with the parent(s) and/or product/release information. In some embodiments, act 305 comprises automatically populating a user interface data field corresponding to the work item with at least one of (i) the identified one or more parents, (ii) a software product family, (iii) a software product, or (iv) a software release version. For example, if work item 205h was identified as part of its creation user interface(s) 115, the object association component 111 could provide the user interface(s) 115 with the identity of the parent objects/nodes that were identified by the parenting analysis component 110 in act 303. As a result, the user interface(s) 115 might fill these parent objects/nodes into one or more user interface fields (e.g., drop-down menus, combo boxes, text input boxes, and the like). In another example, the object association component 111 could provide the user interface(s) 115 with the identity of a software product family, software product, release version, etc. identified from the parent objects/nodes. As a result, the user interface(s) 115 might fill this software product/release information into one or more user interface fields (e.g., drop-down menus, combo boxes, text input boxes, and the like). In embodiments, if a user modifies one of these auto-filled user interface fields, the auto parenting component 107 might update the resource management data structure(s) 116a, and apply this new information to aid in making future auto parenting decisions, such as by updating relevant historical data, updating a machine learning model, and the like. Thus, act 305 could also include an act of receiving user input directed at the data field, the user input providing an alternate data field value (e.g., alternate parent(s), alternate software product/release information, etc.) and, based on the user input, updating the resource management structure (e.g., with the new parent associations, with the new software product/release information, etc.).

Additionally, or alternatively, method 300 can include an act 306 of allocating hardware resources based on the association. In some embodiments, act 306 comprises, based on having associated the work item with the one or more parents of the work item in the resource management structure, allocating of at least one of storage hardware resources, processing hardware resources, memory hardware resources, or networking hardware resources to a computer system associated with the work item. For example, based (at least in part) on the association(s) created by object association component 111, the resource management engine 112 could allocate or re-allocate physical computing resources 117 to one or more computer systems (e.g., corresponding to users, teams, etc.).

Notably, using auto parenting to maintain up-to-date resource management structure(s) 116a can lead to many opportunities for workflow automation and/or data maintenance. For examples, fixed bugs might be auto-closed after the affected code has reached a master code branch (e.g., after a delay of 30 days from date the code reached the master branch), resolved bugs could be auto-closed after resolution (e.g., after a delay of 30 from the resolution date); deliverables could be automatically marked as completed when all the child tasks have been completed; tasks could be automatically cut (i.e., removed) when their parent deliverables have been cut, etc.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize one or more special-purpose or general-purpose computer systems that each includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, implemented at a computer system that includes one or more processors, for automatically populating a user interface data field based on auto parenting of a work item in a resource management structure, the method comprising:
identifying a work item that corresponds to at least one source code item in a source code database, the work item being associated with a user;
identifying historical data relevant to the work item, the historical data including one or more of (i) one or more first prior work item mappings by the user associated with the work item, (ii) one or more second prior work item mappings by one or more peers of the user associated with the work item, or (iii) one or more third prior work item mappings associated with the source code item;
based on the identified historical data relevant to the work item, identifying one or more parents of the work item in a resource management structure, the one or more parents representing one or more software features to which the work item contributes;
associating the work item with the one or more parents of the work item in the resource management structure; and
automatically populating a user interface data field corresponding to the work item with at least one of (i) the identified one or more parents, (ii) a software product family, (iii) a software product, or (iv) a software release version.

2. The method of claim 1, further comprising:
receiving user input directed at the data field, the user input providing an alternate data field value; and
based on the user input, updating the resource management structure.

3. The method of claim 1, further comprising, based on having associated the work item with the one or more parents of the work item in the resource management structure, allocating of at least one of storage hardware resources, processing hardware resources, memory hardware resources, or networking hardware resources to a computer system associated with the work item.

4. The method of claim 1, wherein the work item corresponds to at least one of a bug or a task associated with the at least one source code item.

5. The method of claim 1, wherein associating the work item with the one or more parents in the resource management structure comprises inserting the work item as an object in the resource management structure, the object being inserted hierarchically below one or more objects representing the one or more parents in the resource management structure.

6. The method of claim 1, wherein associating the work item with the one or more parents in the resource management structure comprises linking the work item into the resource management structure, the work item being linked hierarchically below the one or more parents in the resource management structure.

7. The method of claim 6, wherein linking the work item into the resource management structure comprises linking an object in the source code database to one or more objects representing the one or more parents in the resource management structure.

8. The method of claim 1, wherein objects in the resource management structure are defined based on a taxonomy, and wherein the work item comprises an object created according to the taxonomy.

9. The method of claim 1, wherein the one or more parents identify at least one software feature implemented by the work item.

10. The method of claim 1, wherein the method operates based on at least one of (i) the work item being identified as orphaned, or (ii) creation of the work item.

11. The method of claim 1, wherein identifying the one or more parents of the work item in the resource management structure based on the identified historical data relevant to the work item comprises applying a weighting between two or more of the one or more first prior work item mappings by the user associated with the work item, the one or more second prior work item mappings by the one or more peers of the user associated with the work item, and the one or more third prior work item mappings associated with the source code item.

12. A method, implemented at a computer system that includes one or more processors, for automatically allocating hardware resources based on auto parenting of a work item in a resource management structure, the method comprising:
identifying a work item that corresponds to at least one source code item in a source code database, the work item being associated with a user;
identifying historical data relevant to the work item, the historical data including one or more of (i) one or more first prior work item mappings by the user associated with the work item, (ii) one or more second prior work item mappings by one or more peers of the user associated with the work item, or (iii) one or more third prior work item mappings associated with the source code item;
based on the identified historical data relevant to the work item, identifying one or more parents of the work item in a resource management structure, the one or more parents representing one or more features to which the work item contributes;
associating the work item with the one or more parents of the work item in the resource management structure; and
based on having associated the work item with the one or more parents of the work item in the resource management structure, automatically allocating of at least one of storage hardware resources, processing hardware resources, memory hardware resources, or networking hardware resources to a computer system associated with the work item.

13. The method of claim 12, further comprising automatically populating a user interface data field corresponding to the work item with at least one of (i) the identified one or more parents, (ii) a software product family, (iii) a software product, or (iv) a software release version.

14. The method of claim 13, further comprising:
receiving user input directed at the data field, the user input providing an alternate data field value; and
based on the user input, updating the resource management structure.

15. A computer system comprising:
one or more processors; and
one or more computer-readable media having stored thereon computer-executable instructions that are executable by the one or more processors to cause the computer system to automatically parent a work item in a resource management structure, the computer-executable instructions including instructions that are executable by the one or more processors to perform at least the following:
identify a work item that corresponds to at least one source code item in a source code database, the work item being associated with a user;
identify historical data relevant to the work item, the historical data including one or more of (i) one or more first prior work item mappings by the user associated with the work item, (ii) one or more second prior work item mappings by one or more peers of the user associated with the work item, or (iii) one or more third prior work item mappings associated with the source code item;
based on the identified historical data relevant to the work item, identify one or more parents of the work item in a resource management structure, the one or more parents representing one or more features to which the work item contributes; and
associate the work item with the one or more parents of the work item in the resource management structure.

16. The computer system of claim 15, wherein the computer-executable instructions also include instructions that are executable by the one or more processors to automatically populate a user interface data field corresponding to the work item with at least one of (i) the identified one or more parents, (ii) a software product family, (iii) a software product, or (iv) a software release version.

17. The computer system of claim 15, wherein the computer-executable instructions also include instructions that are executable by the one or more processors to automatically allocate of at least one of storage hardware resources, processing hardware resources, memory hardware resources, or networking hardware resources to a computer system associated with the work item, based on having associated the work item with the one or more parents of the work item in the resource management structure.

18. The computer system of claim 15, wherein associating the work item with the one or more parents in the resource management structure comprises inserting the work item as an object in the resource management structure, the object being inserted hierarchically below one or more objects representing the one or more parents in the resource management structure.

19. The computer system of claim 15, wherein associating the work item with the one or more parents in the resource management structure comprises linking the work item into the resource management structure, the work item being linked hierarchically below the one or more parents in the resource management structure.

20. The computer system of claim 15, wherein identifying the one or more parents of the work item in the resource management structure based on the identified historical data relevant to the work item comprises applying a weighting between two or more of the one or more first prior work item mappings by the user associated with the work item, the one or more second prior work item mappings by the one or more peers of the user associated with the work item, and the one or more third prior work item mappings associated with the source code item.
